(19) United States
(12) Patent Application Publication
(10) Pub. No.: US 2012/0117090 A1
(43) Pub. Date: May 10, 2012

(54) SYSTEM AND METHOD FOR MANAGING DIGITAL CONTENTS

(75) Inventors: Han Sung Lee, Yongin (KR); Yun Su Chung, Daejeon (KR); So Hee Park, Daejeon (KR); Yong Jin Lee, Ansan (KR); Jeong Nyeo Kim, Daejeon (KR); Hyun Sook Cho, Daejeon (KR)

(73) Assignee: Electronics and Telecommunications Research Institute, Daejeon (KR)

(21) Appl. No.: 13/286,682

(22) Filed: Nov. 1, 2011

(30) Foreign Application Priority Data
Nov. 4, 2010 (KR) 10-2010-0109298

(51) Int. Cl. G06F 17/30

(52) U.S. Cl. 707/752; 707/E17.002

(57) ABSTRACT

Disclosed are a system and method for managing digital contents. An exemplary embodiment according to the present invention provides to a system for managing digital contents, including a learning module extracting feature vectors of input digital contents and performing column subspace mapping on the feature vectors to calculate a column subspace projection matrix; an index module using the matrix to perform an index work on the digital contents and then, storing the matrix and the digital contents; and a search module performing the column subspace mapping on the feature vectors of query data when the query data for searching the digital contents are input and searching the digital contents indexed by the matrix having high similarity to the mapped feature vectors of the query data.

### CROSS-REFERENCE TO RELATED APPLICATIONS

This application claims priority under 35 U.S.C. §119 to Korean Patent Application No. 10-2010-0109298, filed on Nov. 4, 2010, in the Korean Intellectual Property Office, the disclosure of which is incorporated herein by reference in its entirety.

### TECHNICAL FIELD

The present invention relates to a method for managing digital contents, and more particularly, to a system and method for managing digital contents capable of effectively managing digital contents through subspace learning.

### BACKGROUND

Recently, various digital contents including multimedia data have been suddenly increased with the development of an information and communication technology. Therefore, it is more difficult to classify or retrieve desired knowledge information from vast digital contents. The multimedia databases and digital content retrieval methods were the subject of extensive research over the past decade, to develop effective and efficient tools for manipulation, retrieval and analysis of digital contents.

Although the various research results have been achieved, the real world applications are not substantially developed and used. Because it is difficult to extract semantic feature from digital contents and extracted feature vector is too high dimensional.

To meet first problem of the above, there are ongoing attempts to extract feature of semantic level by adopting the multi-modality methods.

To resolve the aforementioned high dimensionality problem, in general, the data analysis or dimensionality reduction methods are employed. The principal component analysis (PCA) is most popular one. The PCA captures most underlying structure of original data well, thus it can be used for dimensionality reduction without performance declination of system. The PCA works well for a single clustered data according to normal distribution, and there is a limitation in representing data that do not follow normal distribution or are represented by several clusters.

As another data analysis mechanism of the high-dimensional feature vector, there is a linear discriminative analysis (LDA) based method of determining an axis capable of optimally separating the data cluster. However, it cannot basically perform the learning when the LDA does not receive learning data of a predetermined number or more to each cluster and cannot be used even when the number of the learning data for each cluster is not constant or is less.

As another method, there are a manifold learning method, a non-negative matrix factorization method, and the like.

The manifold learning method cannot process an unseen test sample by the system and is hard to search a hyper parameter, such that it shows good performance in view of experimental data but does not show good performance when being used in actual data.

The NMF method has excellent performance but takes much time to learn and cannot exclude the case where local optimization values are searched.

Therefore, a need exists for a new method to overcome the limitations of the above-mentioned methods.

### SUMMARY

An exemplary embodiment of the present invention provides a system for managing digital contents, including: a learning module extracting feature vectors of input digital contents and performing column subspace mapping on the feature vectors to calculate a column subspace projection matrix; an index module using the matrix to perform an index work on the digital contents and then, storing the matrix and the digital contents; and a search module performing the column subspace mapping on the feature vectors of query data when the query data for searching the digital contents are input and searching the digital contents indexed by the matrix having high similarity to the mapped feature vectors of the query data.

Another exemplary embodiment of the present invention provides a method for managing digital contents, including: extracting feature vectors of input digital contents; calculating a column subspace projection matrix performing column subspace mapping on the feature vectors; and storing the matrix and the digital contents after performing an index work on the digital contents using the matrix.

Other features and aspects will be apparent from the following detailed description, the drawings, and the claims.

### BRIEF DESCRIPTION OF THE DRAWINGS

FIG. 1 is a flow chart showing a system for managing digital contents according to an exemplary embodiment of the present invention.

FIG. 2 is a flow chart showing a subspace learning method according to an exemplary embodiment of the present invention.

FIG. 3 is a flow chart showing a method for searching digital contents according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, exemplary embodiments of the present invention will be described in detail with reference to the accompanying drawings.

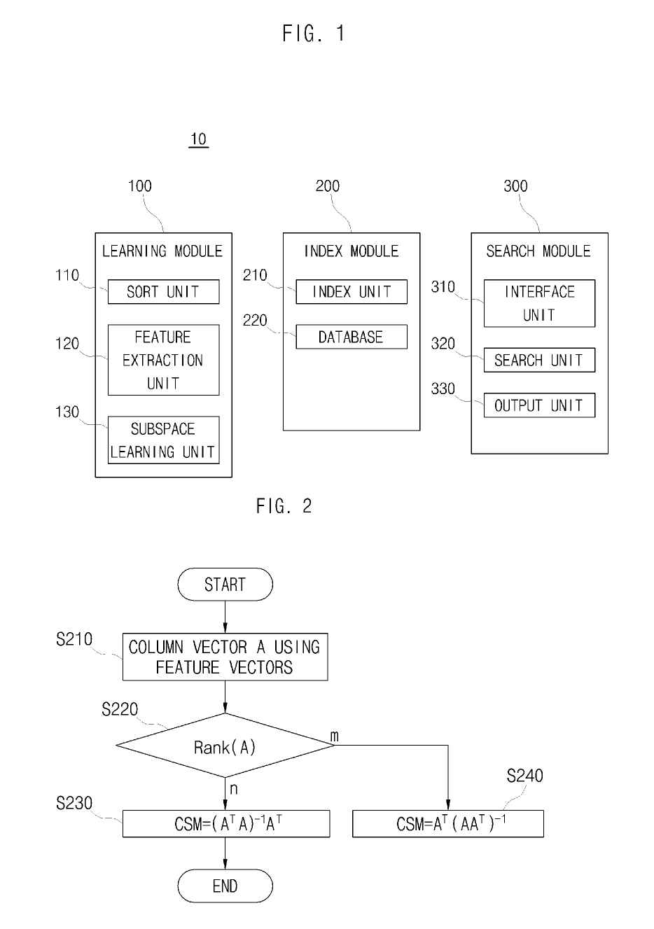

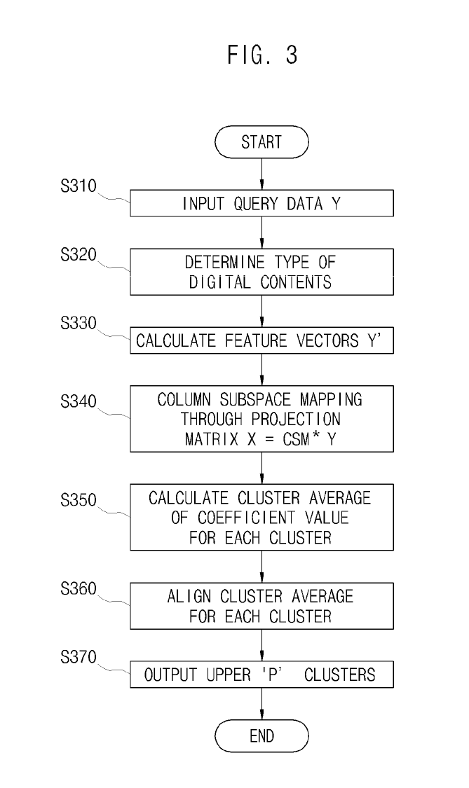

FIG. 1 is a flow chart showing a system for managing digital contents according to an exemplary embodiment of the present invention, FIG. 2 is a flow chart showing a subspace learning method according to an exemplary embodiment of the present invention, and FIG. 3 is a flow chart showing a method for searching digital contents according to an exemplary embodiment of the present invention.

As shown in FIG. 1, a system 10 for managing digital contents according to the exemplary embodiment of the present invention includes a learning module 100, an index module 200, and a search module 300.

First, the system 10 for managing digital contents performs a different function in the case where registered data are input and in the case where query data are input. Hereinafter, a function of each component of the system 10 for managing digital contents will be described in consideration of each case.

The learning module 100 extracts optimized feature vectors from the input digital contents when the registered data that is, the digital contents are input.

In this case, the learning module 100 includes a sort unit 110, a feature extraction unit 120, and a subspace learning unit 130.

The sort unit 110 sorts the digital contents into a text, a still image, an audio, a moving picture, etc.

The feature extraction unit 120 extracts the feature vectors for each type of the digital contents in a manner predetermined for each feature vector.

For example, the feature extraction unit 120 extracts the feature vectors using a word frequency in case of the text and extracts the feature vectors using a method such as color histogram, etc., in case of the still image. In addition, the feature extraction unit 120 extracts the feature vectors by a multi-modality method simultaneously using a script and information on a multimedia file in case of the audio or the moving picture.

The subspace learning unit 130 performs the subspace learning for the extracted feature vectors to calculate the optimized feature vectors, that is, a column subspace projection (hereinafter, referred to as “CSM”) matrix, as in steps (S210) to (S240) of FIG. 2.

The subspace learning unit 130 uses m-dimensional n extracted feature vectors as a basis vector as shown in FIG. 2 to generate matrix A using each feature vector as a column vector as expressed by the following Equation 1 (S210).

A=[v₁, v₂, v₃, . . . , vₙ] [Equation 1]

Further, the subspace learning unit 130 confirms whether Rank of matrix A is m or n (S220).

In this case, the subspace learning unit 130 calculates the CSM matrix by the following Equation 2 if it is determined that the Rank of matrix A is n (S230).

CSM=(A^{T}A)⁻A^{T} [Equation 2]

The subspace learning unit 130 calculates the CSM matrix by the following Equation 3 if it is determined that the Rank of matrix A is m (S240).

CSM=A^{T}(AA^{T})⁻¹ [Equation 3]

As described above, through Equations 2 or 3, the subspace learning unit 130 may calculate the CSM matrix of a pseudo orthogonal type that may have a high coefficient value regarding specific clusters of the feature vectors while reducing dimension, and calculate a value approaching 0 regarding the remaining clusters.

The index module 200 includes an index unit 210 and a database 220 and indexes and stores the digital contents using the CSM matrix.

The index unit 210 performs the index work on the digital contents using the CSM matrix and then, stores the digital contents and the CSM matrix in the database 220. That is, the index unit 210 links the CSM matrix with the digital contents so as to search the digital contents when the index unit 210 searches the CSM matrix.

As shown in FIG. 3, the search module 300 searches the digital contents corresponding to query data among the digital contents stored in the database 220 when the query data are input.

The search module 300 includes an interface unit 310, a search unit 320, and an output unit 330.

The interface unit 310 provides an input interface for a user, receives query data y from the user, and transfers the received query data to the sort unit 110 of the learning module 100 (S310).

The sort unit 110 analyzes the query data to confirm a type of digital contents to be searched by the user (S320).

The feature extraction unit 120 extracts feature vectors y′ in consideration of a type of query data.

The contents search unit 320 multiplies the CSM matrix by the query data y as expressed by the following Equation 4 using the CSM matrix generated by the above Equation 2 or Equation 3 to map the feature vector to the column subspace (S340).

xₒₚₜ=CSM×y [Equation 4]

The contents search unit 320 calculates a cluster average of coefficient values for each cluster of a vector xₒₚₜ that is subjected to the column subspace mapping (S350).

The contents search unit 320 aligns the calculated cluster average (S360) and selects the upper P clusters (S370).

Thereafter, the output unit 330 outputs the upper P clusters selected by the contents search unit 320 to the user.

Through steps (S350) to (S370), the contents search unit 320 may search the digital contents indexed by the CSM matrix having high similarity to the feature vectors.

Meanwhile, the subspace learning unit 130 may use the column vectors of the feature vectors as the basis vector to perform the subspace mapping as described above, or may construct a new matrix with central vectors of each cluster and determine the column vectors of the new matrix as the basis vector.

As described above, the exemplary embodiment of the present invention selects the column vectors of the feature vectors for the subspace learning as the basis vector, need not to limit the number of data for each cluster and the same algorithm can be used when registering a single data or multiple data for each cluster.

As set forth above, the exemplary embodiment of the present invention can perform subspace learning regardless of the number of registered data, thereby making it possible to provide stable performance in searching various fields of multimedia.

Further, the exemplary embodiment of the present invention applies the index and search of the same algorithm for the feature vectors of the digital contents, thereby making it possible to provide the general purpose framework capable of searching various kinds of digital contents.

In addition, the exemplary embodiment of the present invention is applied to various fields of industries, such as the Internet industry, the search engine industry, the security industry, etc., thereby making it possible to activate the corresponding industrial fields.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for managing digital contents, comprising:
a learning module extracting feature vectors of input digital contents and performing column subspace mapping on the feature vectors to calculate a column subspace projection matrix;
an index module using the matrix to perform an index work on the digital contents and then, storing the matrix and the digital contents; and
a search module performing the column subspace mapping on the feature vectors of query data when the query data for searching the digital contents are input and searching the digital contents indexed by the matrix having high similarity to the mapped feature vectors of the query data.

2. The system of claim 1, wherein the learning module includes:
a sort unit sorting a type of the digital contents;
a feature extraction unit extracting the feature vectors of the digital contents in a predetermined manner according to the sorting; and
a subspace learning unit performing subspace learning on the feature vectors to calculate a column subspace projection matrix.

3. The system of claim 2, wherein the sort unit sorts the digital contents based on a text, a still image, an audio, and a moving picture.

4. The system of claim 2, wherein the feature extraction unit extracts the feature vectors using a word frequency when the digital contents is a text, extracts the feature vectors by a method including a color histogram when the digital contents is a still image, and extracts the feature vectors by a method including a multi-modality method when the digital contents is an audio or a moving picture.

5. The system of claim 2, wherein the subspace learning unit calculates the matrix (CSM) using following Equation 1 or Equation 2
CSM=A^{T}(AA^{T})⁻¹ Equation 1:
CSM=(A^{T}A)⁻¹A^{T} (where, A is the feature vectors). Equation 2:

6. A method for managing digital contents, comprising:
extracting feature vectors of input digital contents;
calculating a column subspace projection matrix performing column subspace mapping on the feature vectors; and
storing the matrix and the digital contents after performing an index work on the digital contents using the matrix.

7. The method of claim 6, further comprising:
performing the column subspace mapping on the feature vectors of query data when the query data for searching the digital contents are input; and
searching the digital contents indexed by the matrix having high similarity to the mapped feature vectors of the query data.

8. The method of claim 6, wherein the extracting of the feature vectors includes:
sorting a type of the digital contents;
extracting the feature vectors of the digital contents in a predetermined manner according to the sorting; and
calculating the column subspace projection matrix by performing the column subspace learning on the feature vectors.

9. The method of claim 8, wherein the extracting of the feature vectors includes at least one of:
extracting the feature vectors using a word frequency when the digital contents is a text;
extracting the feature vectors by a method including a color histogram when the digital contents is a still image; and
extracting the feature vectors by a method including a multi-modality method when the digital contents is an audio or a moving picture.

10. The method of claim 6, wherein the calculating calculates the matrix using following Equation 1 or Equation 2
CSM=A^{T}(AA^{T})⁻¹ Equation 1:
CSM=(A^{T}A)⁻¹A^{T} (where, A is the feature vectors). Equation 2:
